(19) United States
(12) Patent Application Publication
(10) Pub. No.: US 2011/0173753 A1
(43) Pub. Date: Jul. 21, 2011

(54) SPECIALIZED TABLETOPS FOR MEDICAL IMAGING

(76) Inventors: Christopher Alexander Luginbuhl, (US); Cameron Anthony Piron, (US); Donald B. Plewes, (US)

(21) Appl. No.: 13/027,870

(22) Filed: Feb. 15, 2011

Related U.S. Application Data
(63) Continuation of application No. 11/447,053, filed on Jun. 5, 2006, now abandoned.
(60) Provisional application No. 60/687,420, filed on Jun. 3, 2005.

(51) Int. Cl. A61G 13/02

(52) U.S. Cl. 5/601

(57) ABSTRACT

A system of interchangeable specialized tabletops for medical imaging, such as tomographic imaging, is constructed with features that permit improvements in patient imaging and treatment specific to a particular anatomy of interest. Such features include cutaways, holes and removable structures, ramps and integrated devices that allow access to tissues for intervention or imaging under multiple imaging modalities. Such features are also integrated, which aids in the positioning and immobilization of patient tissues and devices relative to those tissues. Structures and methods optimally use multiple tabletops with minimal space requirements, and of show medical imaging uses involving the storage of multiple tabletops.

### RELATED APPLICATION DATA

The present application is a continuation of U.S. patent application Ser. No. 11/447,053, filed Jun. 5, 2006, which claims priority to Provisional U.S. Patent Application No.: 60/687,420, filed Jun. 3, 2005, and titled Specialized Tabletops for Medical Imaging, each of which is hereby incorporated by reference in its entirety.

### BACKGROUND OF THE INVENTION

1. Field of the Invention

The present invention relates to medical imaging and patient supports or tabletops for medical imaging and especially for tomographic imaging. Tabletops, transport mechanisms and a remote preparation station are used to enhance imaging and intervention capability and facilitate patient handling processes using minimal floor space.

2. Description of Prior Art

It is preferable that the tabletop used in a tomographic system such as X-ray computerized tomography (CT) or magnetic resonance imaging (MRI) be free to detach from the imaging apparatus in order to i) freely remove the patient from the presence of the room and its associated magnetic field (if any) ii) be able to prepare the patient outside of the imaging room or iii) use more than one tabletop in connection with the imager, so as to save time by interleaving or multiplexing the patient handling and scanning aspects of the total imaging time for each patient.

A number of different shapes and forms of imagers are in use, most having an annular form, with the patient being imaged in the central aperture which extends through the length of the machine. Some MRI imagers have an imaging volume characterized by an open gap bracketed by large plates either on both sides of the patient or on top and underneath the patient. Although annular imagers are shown in figures provided in this description, the presently described technology and the invention applies to imagers of all types.

Some imagers (as in 24 of FIG. 2) have a patient transporter 2 that is used to remove just the tabletop 4 from the imager. The tabletop 4, 6 is normally mounted either on wheels 72 (see FIG. 13) or on a horizontal stage 8 so that it can be advanced to position for imaging (FIG. 4), or removed to the home position (FIG. 3). The imager system 24 in FIG. 2 forms the basis for U.S. Pat. No. 6,101,644.

Similarly, U.S. Pat. No. 6,854,140 (Bartels) describes a transport carriage for a patient bed having a first arm for placement of the patient bed thereon and a second arm for coupling the patient bed thereto. A medical treatment or examination system employing such a transport carriage has a number of medical devices for treatment of examination of a subject, each of these medical devices having a patient support mechanism associated therewith, with a differently configured patient bed. The patient beds are removable from the respective support mechanisms, and the transport carriage is configured to receive and transport any of these differently configured patient beds.

U.S. Pat. No. 6,205,347 (Howard) describes a multi-modality diagnostic imaging system includes a first imaging subsystem (A), such as a computed tomographic (CT) system, for performing a first imaging procedure on a subject. A second imaging subsystem (B), such as a nuclear medicine system (NUC), performs a second imaging procedure on a subject. The second imaging subsystem (B) is remote from the first imaging system (A). A patient couch (28) supports a subject. A patient transfer subsystem (C) transfers a patient couch (28) between the first imaging subsystem (A) and the second imaging subsystem (B). The first and second imaging subsystems (A, B) can be operated concurrently to perform different imaging procedures on different subjects supported by separate patient couches. Data generated by the first imaging subsystem (A) can be used to correct emission data generated by the second imaging subsystem (B).

Transporters are conventionally used to displace tabletops and any patients thereon. In use, the tabletop is rigidly coupled to the transporter so that no relative motion of the tabletops to the transporter is permitted. The coupling can occur with a frictional connection or a clamping means.

There is normally a vertical stage 10 (FIG. 2) integrated with the imager permitting a vertical translation of the tabletop. If the transporter 2 is not used to prepare and position the patient away from the imager, then the vertical stage 10 may be used to lower the tabletop to ease patient positioning. An alternate embodiment 12 of the vertical stage 10 is shown in FIG. 13.

FIG. 2 and FIG. 5 show a patient transporter that is positioned for use at the end of the tabletop when the tabletop is at the home position. Similarly, FIGS. 13 and 14 show an alternate patient transporter 14 which is positioned from the side of the tabletop in conjunction with imagers whose vertical stage 12 is affixed to the floor.

It is often advantageous to use the imager's vertical stage 10, 12 to remove the supporting means from under the tabletop whenever the transporter is being used to install or remove the tabletop (FIG. 6 and FIG. 7).

Another attribute of imaging transport systems is to provide such a system which makes it easy to provide multiple tabletops without greatly increasing the floor space needed for the use and storage of multiple tabletops. FIG. 8 demonstrates a means of interleaving tabletops on transporters of an established type, not a subject of this invention. The vertically adjustable upper stage 48 of those transporters puts the next tabletop to be used in the topmost position. This ensures that the patient may be freely positioned on the topmost tabletop, and can even be returned to this position after imaging where intervention or subsequent treatment may be performed. A second tabletop is in storage underneath, where it does not require significant floor space for storage.

To save imager time by preparing a subsequent patient while a first patient is being scanned, it is normally necessary to have two or more transporters and two or more tabletops. There is no evidence in the prior art of any system using fewer transporters than tabletops for an imaging or patient handing (e.g. a system using three or more tabletops with only two transporters). Additionally, if more than two tabletops are to be used in such a system, the tabletops cannot be interleaved in the manner shown in FIG. 8, and the space needed for storage of the tabletops and transporters increases.

In U.S. Pat. Nos. 5,259,011, 5,842,987, the authors claim time saving resulting from multiplexing the patient imaging and preparation portions of a clinical exam. A more elaborate scheme for multiplexing is presented by Damadian in U.S. Pat. Nos. 5,490,513 and 5,623,927, which use an MRI into which patients are introduced through two or more openings.

U.S. Pat. No. 4,727,328 (Carper et al.) claims a patient transport stretcher, and U.S. Pat. No. 4,956,885 (Alich, et al.) describes a cantilevered fiberglass stretcher for MRI, of the type shown in FIG. 2. U.S. Pat. No. 4,914,682 (Blumenthal) describes a tabletop which is removable from the imager.

InSightec (www.insightec.com) currently markets the ExAblate™2000, a system using a dedicated MRI tabletop which comprises ultrasound transducers and a transducer positioning system which are used to thermally ablate tissues in the breast or uterus. The system is described in U.S. Pat. No. 6,735,461 (Vitek, et al.). The system is intended to deliver therapy using ultrasound while in the MRI's bore. The ultrasound is never used for imaging. There is no additional access to, or imaging of the patient permitted by the system. This system is retrofitted to a standard General Electric stretcher.

U.S. patent application Ser. No. 10/916,738, filed 12 Aug. 2004, titled “HYBRID IMAGING METHOD TO MONITOR MEDICAL DEVICE DELIVERY AND PATIENT SUPPORT FOR USE IN THE METHOD,” describes a system having a dedicated stretcher combined with a dedicated tabletop for improved access to the breast. The tabletop 18 shown in FIG. 1 is substantially similar to one described and illustrated in that application. The inventors are the same as those of the present disclosure. This application is incorporated herein by reference in its entirety.

A number of adaptations to these standard technologies for purposes of intervention have been described. U.S. Pat. No. 6,459,923 (Plewes et al.) claims a stretcher having an interventional area which is used by removing a section from the tabletop to provide access for intervention. The invention thus comprises two shorter tabletops which are bridged together, and which rely on the support of a stretcher which has a corresponding section of its top missing. There is also a means of bridging the gap in the stretcher on which the tabletop lies, so that the tabletop has a support for its wheels to roll on as it is advanced into the imaging volume. This type of bed is also described by in U.S. Pat. No. 5,729,849 (Garakani).

U.S. Pat. No. 6,446,286 claims patient imaging tables having regions of reduced radiation attenuation which are variously described as holes, thin areas, or areas of different materials to be used in nuclear imaging.

U.S. Pat. No. 6,776,527 details a means of using a stretcher to repeatably bring a table top and patient into a known position with a CT scanner relative to a PET scanner.

U.S. patent application Ser. No. 2004102690 details a transporter which attaches to tabletops that can be used with different types of imagers. This invention is intended to ease patient handling by removing the need to transfer the patient from one patient support to another.

British patent GB2394412 describes a transporter which has tabletop support elements which can accept and support two or more different tabletops, i.e. a computer tomography tabletop, and MRI tabletop, and angiographic tabletop, etc. Tabletops having different contours are supported in such a way as to prevent unintentional lateral displacement. This enables imaging the same patient with multiple imaging technologies without repositioning the patient on separate tables, but does not add any new capabilities to those provided by the individual imaging technologies.

U.S. Pat. No. 6,640,364 details a tabletop that is used to co-register MRI and X-ray images, by keeping the patient in the same configuration while transporting them from one imaging system to the other. They specify that the motion be in a straight line away from the MRI. Although the X-ray pedestal has rails intended to facilitate linear motion of the tabletop and the tabletop is said to be accepted by either imaging system, there is no apparent means for physically transferring it to the MRI's stretcher. No multiple tabletops or special features of the tabletop are indicated.

A similar invention is claimed by Olszewski, et al. in DE29818100U, in which a patient lies on a horizontally slidable tabletop and can thus be delivered from an X-ray computer tomography machine to a nearby support surface whose support columns are moveable, thus providing access for a c-arm x-ray machine. Again, no mention is made of multiple tabletops or tabletops for special purposes.

Similarly, U.S. Pat. No. 5,619,763 describes a means for transferring a tabletop from a support to a pedestal to improve the ability to position patients for nuclear imaging. Although this patent mentions transferring tabletops from one means of support to another, neither tabletop support nor pedestal permits access to the underside of the tabletop and the tabletop is not said to embody any special features. Only transferring by rolling longitudinally is detailed.

EP0501071 (Deucher et al.) claims a means of storing a patient couch for a CT scanner, such that it will fit within a standard military enclosure. They are able to reduce the floor space required for the patient stretcher by storing on an oblique angle. They do not save space when storing multiple stretchers, or when the stretcher is in use.

### SUMMARY OF THE INVENTION

The original technology described herein provides a class or tabletops including the plurality of different tabletops (FIG. 1) for a tomographic imaging system such as X-ray computerized tomography (CT) or magnetic resonance imaging (MRI). The various tabletops include specially optimized systems for imaging or intervention of a particular body part. These tabletops may be configured to fit various MRI vendors standard systems (Siemens, Toshiba, Philips, as non-limiting examples). These MRI systems in particular are commercially available with the ability to interchange a second, identical tabletop using a dedicated tabletop transporter as shown in FIGS. 2-7 and FIGS. 13-14.

In accordance with the presently described technology, two or more tabletops are interchanged using any one of several types of transporters (FIGS. 8 and 9). If it is desirable to reduce the number of transporters used while making use of multiple tabletops, and thus there are more tabletops than transporters, a preparatory station (FIG. 10) may be used in conjunction with one or more transporters for the storage of multiple tabletops, patient preparation, and for performing intervention.

Specialized tabletops may be installed in place of the normal tabletop, in addition to (placed on top of or clamped on top of) the normal tabletop, either in the usual manner or overhanging one or another end of the ordinary tabletop supports.

There is a plurality of permutations where multiple embodiments exist for different aspects of the system. A viable system comprises one element from each of the following:

tabletop purpose (breast, prostate, etc)

on top of original tabletop or replacing original tabletop

overhanging either end of support (whether that is a stretcher, an MRI or an original tabletop) or not overhanging

Method of placing and removing tabletop (transporter from side 14, transporter from end 2, novel transporter 32)

More than one transporter or using a prep station

### BRIEF DESCRIPTION OF THE DRAWINGS

FIG. 1 shows a perspective view of a variety of tabletops. From top left to right: a normal tomography tabletop (prior art), a tabletop having an aperture for ultrasound examination and/or intervention, a breast imaging tabletop integrating ramps, apertures and provisions for fixturing devices used to immobilize tissue and fixture interventional devices, a prostate tabletop having a cutaway for interventional access, an X-ray tabletop having an integrated flat panel X-Ray detector, a breast imaging tabletop having a removable element, a breast tabletop having multiple apertures. From the bottom left: a prostate interventional tabletop having a foreshortened body support and adjustable leg-supporting stirrups, a prostate interventional tabletop having an upper body support connected to a foot support with arched members.

FIG. 2 (Prior art) shows an exploded view of an imager, showing the transporter and other parts used to position the tabletops.

FIG. 3 (Prior art) shows a perspective view of an imager showing the normal tabletop at the home position.

FIG. 4 (Prior art) shows a perspective view of an imager with the normal tabletop advanced by the horizontal stage to the scan position.

FIG. 5 (Prior art) shows a perspective view of an imager with a transporter engaged with the normal tabletop.

FIG. 6 (Prior art) shows a perspective view of an imager showing a transporter engaged with the normal tabletop and the vertical and horizontal stages lowered in preparation for the removal of the tabletop.

FIG. 7 (prior art) shows a perspective view of an imager with its tabletop withdrawn on a transporter.

FIG. 8 shows a perspective view of Siemens tabletop (prior art) on a transporter (prior art) interleaved with a special-purpose tabletop. Minimal space is used by interleaving them, while it is still possible to perform patient positioning or intervention on the uppermost tabletop according to the novel teachings of the present application.

FIG. 9 shows a perspective view of a Siemens imaging system in combination with a specialized tabletop installed in place of the normal tabletop on the horizontal stage of the imager.

FIG. 10 shows a perspective view of a patient preparatory station away from the imager that integrates lights, mirrors, position tracking devices, vertical adjustability, storage for multiple tabletops, and room for interventional access to a suitable tabletop.

FIG. 11 shows a perspective view of a prep station with a specialized tabletop mounted, showing a Siemens tabletop (prior art) on a transporter (prior art) being delivered to a second storage berth.

FIG. 12 shows a perspective view showing a specialized tabletop removed from a prep station, and positioned on an imager. A Siemens tabletop (prior art) is stored on the prep station.

FIG. 13 (prior art) shows an exploded perspective view of an alternate imager, being representative of a Phillips magnetic resonance imaging system, whose vertically adjusting tabletop support is affixed to the floor, and whose transporter approaches from the side of the tabletop.

FIG. 14 (prior art) shows a perspective view of the Philips imager in FIG. 13.

FIG. 15 shows a perspective view of the Philips imager, where the normal Philips tabletop is stored on a prep station, and a special-purpose tabletop is put in place using a transporter.

FIG. 16 shows a perspective view of an imager showing how its tabletop may be advanced through its bore, so as to leave one end cantilevered out of the end of the imager opposite the vertical stage.

FIG. 17 shows a perspective view of an imager with a special purpose tabletop which sits on top of the normal tabletop, overhanging it, and which is advanced through its bore in order to provide access to the patient through the tabletop's gap.

FIG. 18 shows a perspective view of an imager with a special purpose tabletop which sits in place of the normal tabletop, overhanging the horizontal stage, and which is advanced through its bore in order to provide access to the patient through the tabletop's gap.

FIG. 19 shows a perspective view of an imager with a special purpose tabletop which sits in place of the normal tabletop, overhanging the horizontal and vertical stages, in order to provide access to the patient through the tabletop's gap.

FIG. 20 shows a perspective view of an imager with a special purpose tabletop which sits on top of the normal tabletop, overhanging the normal tabletop and the horizontal and vertical stages, in order to provide access to the patient through the tabletop's gap.

FIG. 21 shows a novel embodiment of a transporter which carries a special purpose tabletop which uses sliding rails that only permit translation in the direction the tabletop travels when advancing to the scan position.

FIG. 22 shows the transporter and tabletop of FIG. 21, where the imager's vertical stage has been lowered to permit the removal of the transporter and tabletop.

FIG. 23 shows an alternate embodiment of the transporter and tabletop of FIGS. 21-22, wherein the special purpose tabletop is to be installed over top of the normal tabletop.

FIG. 24 shows an alternate embodiment of a tabletop for prostate intervention, comprising a

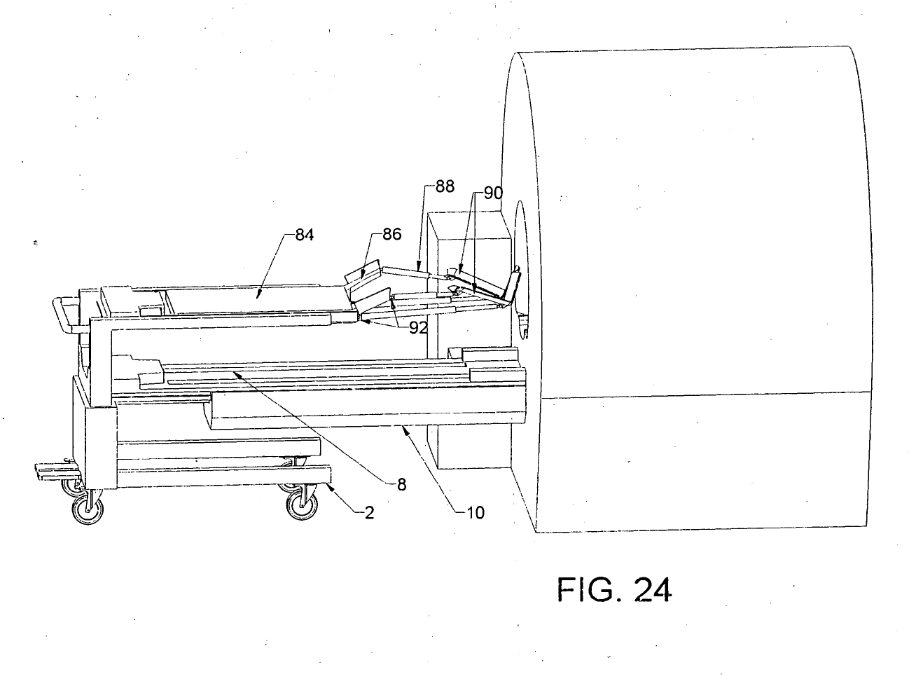

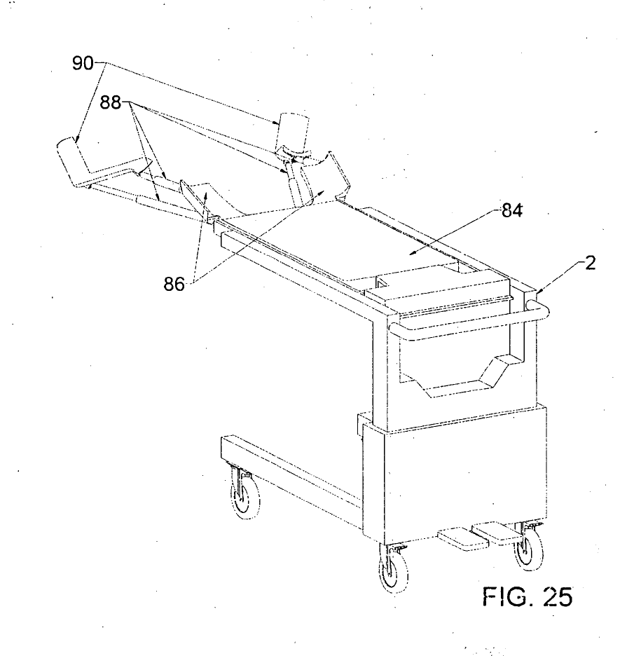

shorter tabletop having ramps and strut-supported stirrups for leg support. FIG. 25 shows the tabletop for prostate intervention of FIG. 24 where the tabletop has been removed from the imager and where the stirrups have been spread apart for improved interventional access.

### GLOSSARY OF NUMBERS IN FIGURES

2 Transporter, end approach (Siemens)

4 table top (“normal table top”)

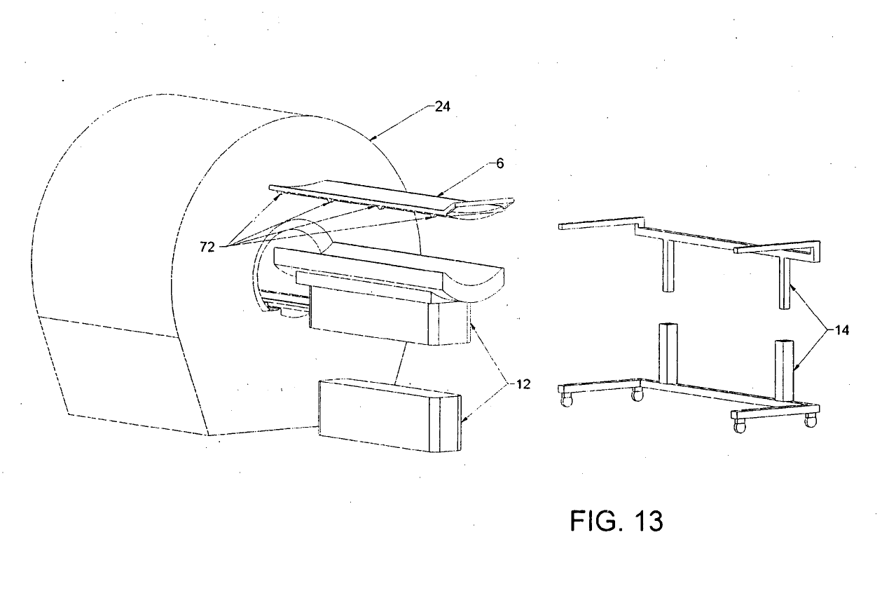

6 Table top on wheels (Philips, FIG. 13)

8 Horizontal stage (Siemens magnet)

10 Vertical stage (Siemens magnet)

12 Alternate embodiment (Philips) of vertical stage.

14 Alternate transporter, side approach (Philips)

16 Special Purpose (US aperture) tabletop

18 Special Purpose (breast) tabletop

20 Special Purpose (prostate) tabletop

22 Special Purpose (X-ray) tabletop

24 “Imager” (MRI or CT)

26 Cantilever constraints

28 T slot bosses

30 T-slots

32 Transporter with T-slot constraint.

34 Bore of imager

36 US aperture

38 ramps (in breast tabletop)

40 Provision for affixing devices for tissue immobilization (compression plates)

42 Cutaway for interventional access (prostate) 44 X-ray flat panel detector

46 Provision for affixing interventional devices.

48 Vertically adjustable upper stage of transporter

50 Multiple berths for tabletops (on prep station)

52 Vertically adjustable storage (on prep station)

54 Position tracking devices (on prep station)

56 Lights (on prep station)

58 Blood catchment (on prep station)

60 Mirrors for patient positioning (on prep station)

62 Feature to guarantee alignment of transporter when releasing or attaching tabletop (on prep station)

64 Wheels (on prep station)

66 Cutout (breast)

68 Simple transporter

70 Prep station

72 Wheels (Philips tabletop)

74 tabletop (breast, removable arch)

76 removable arch

78 arch fixation means

80 tabletop (breast, with CC access)

82 CC access apertures

84 short prostate tabletop

86 ramps (short prostate tabletop)

88 adjustable struts (short prostate tabletop) 90 stirrups (short prostate tabletop)

92 pivot (short prostate tabletop)

94 prostate tabletop

96 arched members (prostate tabletop) 98 interventional gap (prostate tabletop)

### DETAILED DESCRIPTION OF THE INVENTION

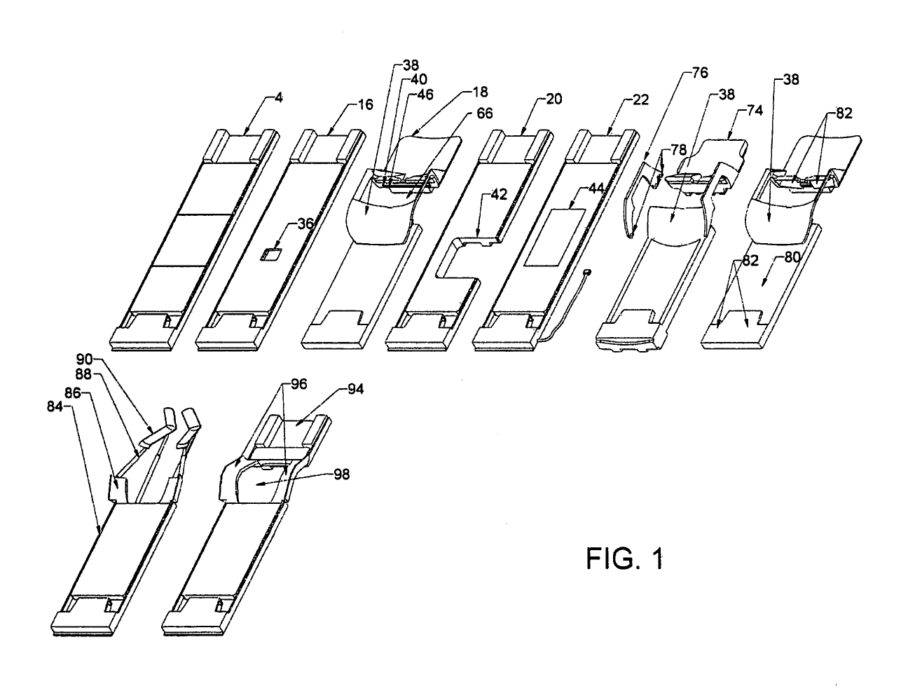

In accordance with the technology described herein, a specialized tabletop is selected from a plurality of tabletop forms (shown in FIG. 1), which tabletop is best suited to the needs of the procedure to be undertaken. Described here are tabletops which integrate features for optimized patient positioning, imaging and intervention such as:

contoured ramps 38 used to elevate and immobilize the anatomy of interest,

apertures 36, 82, 98 to enable physicians to access and to bring devices into contact with selected tissue.

removable structural elements 46, which can safely be removed from the table top when the tabletop is supported by a suitable means, such as a prep station.

integrated imaging devices 44 such as an X-ray flat panel detector.

structures suited to the fixturing of compression plates 40.

structures suited to guidance and fixturing of devices such as interventional probes 46.

actuators which manipulate one or more joints during or between imaging sequences.

a shorter patient support 84 than the normal tabletop 4, enabling improved access to tissues.

support elements such as stirrups 90 to hold the legs and feet of a patient in an adjustable degree of separation and elevation.

supports 90 for body parts having a means of adjustment 88 such that the patients position can be modified for intervention after being imaged.

The systems of the novel technology described herein comprise both novel tabletops and novel carrier systems (transports) and staging platforms for the tabletops to be used in medical imaging and medical operation facilities. The tabletops may be characterized in a number of different ways. The tabletops are preferably fitted with glides, engaging elements, especially longitudinally disposed elements such as rails or other track or rail engaging components so that the tabletop can be moved with facility along, off of, or onto the transporter or onto the tabletops guiding supports on the imager or preparation station. The tabletop may have specific design components and structure to enable specific region body support and specific regions body access for medical procedures. Among these features may be ramps that support one or more of the upper torso, the thorax, the hips, the legs, the arms, the legs, etc. Apertures may be provided on the tabletop to allow access (from underneath the tabletop). Access panels or openings are uniquely provided herein for access to the groin, body or spine region of a patient, as for surgery, diagnosis, treatments, ultrasound imaging, and the like.

Specific structure that can be provided, in addition to mirrors positioned to facilitate practitioner viewing through apertures in the tabletop, lights to facilitate viewing of the patient through apertures in the tabletop and other elements already mentioned, would be pivoting stirrups, pivoting stirrups attached to limb supports, especially for the calves, adjustable body segment supports such as a head, neck or upper torso support that can slide and lock longitudinally, fixed opening in the tabletop support area around preselected body part regions (e.g., around the groin or breasts), fixed openings with complete opening to one side of the tabletop so that patients may be slid into position without having to raise the body of the patient to have the body part extend into an opening in the tabletop, and the like.

Portions of the tabletop that connect ends of the tabletop together across an aperture may be arched, have ramps, and compression plates (for fixing tissue more securely and with greater control of pressure (especially around the apertures where sensitive tissue areas may extend through the apertures).

A preparatory station according to teachings herein comprises a moveable (e.g., rolling) support for multiple tabletops. Guide elements (slide or rail engaging elements) on the individual tabletops may be used to position the individual tabletops onto different levels on the preparatory station, so that individual tabletops may be positioned (e.g., slid) into and out of place on the preparatory station for use as desired. Different tabletop formats may be present on the preparatory station so that individual tabletops may be removed as needed for different procedures or when different steps in a single procedure are needed.

FIG. 1 shows a perspective view of a variety of tabletops 4, 16, 18, 20, 22, 74, 80, 84 and 94. From top left to right, in FIG. 1 shows: a normal tomography tabletop 4 (prior art), a tabletop 16 having an aperture 36 for ultrasound examination and/or intervention, a breast imaging tabletop 18 integrating ramps 38, apertures 36, 42, 66 (cutout for breast positioning) and 82 and provisions for fixturing 40, 46 devices used to immobilize tissue and fixture interventional devices, a prostate tabletop 20 having a cutaway for interventional access, an X-ray tabletop 22 having an integrated flat panel X-Ray detector 44, a breast imaging tabletop 80 having a removable element, a breast tabletop having multiple apertures. There is an element referred to herein as an “arch” which is defined as an element that is grounded or fixed onto a support surface and is elevated above that support surface, with or without the open area in the structure that is normally associated with the classic shape and geometry of an arch. Element 78 shows a two part detachable arch that supports or confines the arms and upper torso of a patient. Element 82 is a combined coil (CC) access or replacement panel. Although the upper torso element 38 is not referred to as an arch, in the image support tabletop 80 furthest to the right, the upper torso element 38 is shown with attached arches. From the bottom left: a prostate interventional tabletop 84 having a foreshortened body support, ramp 86, adjustable struts 88 and adjustable leg-supporting stirrups 90, a prostate interventional tabletop 94 having an upper body support 98 connected to a foot support with arched members 96. The various tabletops have unique individual features that promotes and enables their use in specific or general surgical procedures in combination with imaging techniques. The table tops may be carried, slid, or engaged with supports or into systems. A system compatible edge, or engaging format along the sides and/or bottom of the tabletops would enable their exchangeable use within a known imaging and/or surgical system.

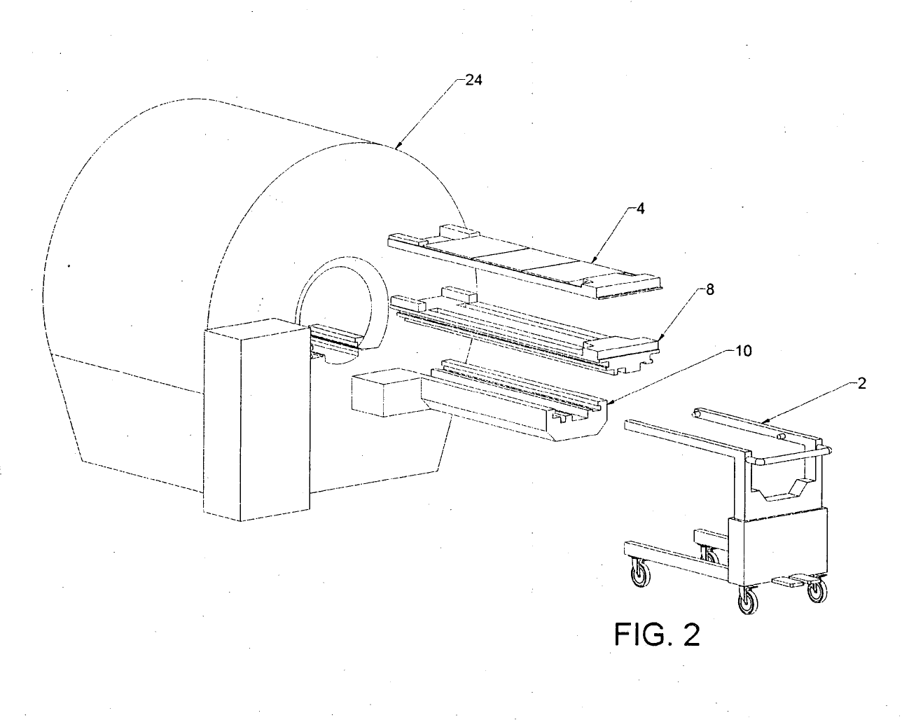

FIG. 2 (Prior art) shows an exploded view of an imager 24, showing the transporter 2 and other parts used to position the tabletops 4 (Note: This is an approximate representation of a Siemens Avanto MRI. See http://www.medical.siemens.com/siemens/en_US/gg_mr_FBAs/images/product_images/GG_Overvie_w/Product_Overview_Avant_HP5.jpg. A horizontal stage 8 for the tabletop is provided as is a vertical stage 10. The tabletop would be carried in concert with the horizontal and vertical stages (8, 10) on the transporter 2, moved to the imager 24, and the patient inserted along with all three components 4, 8 and 10.

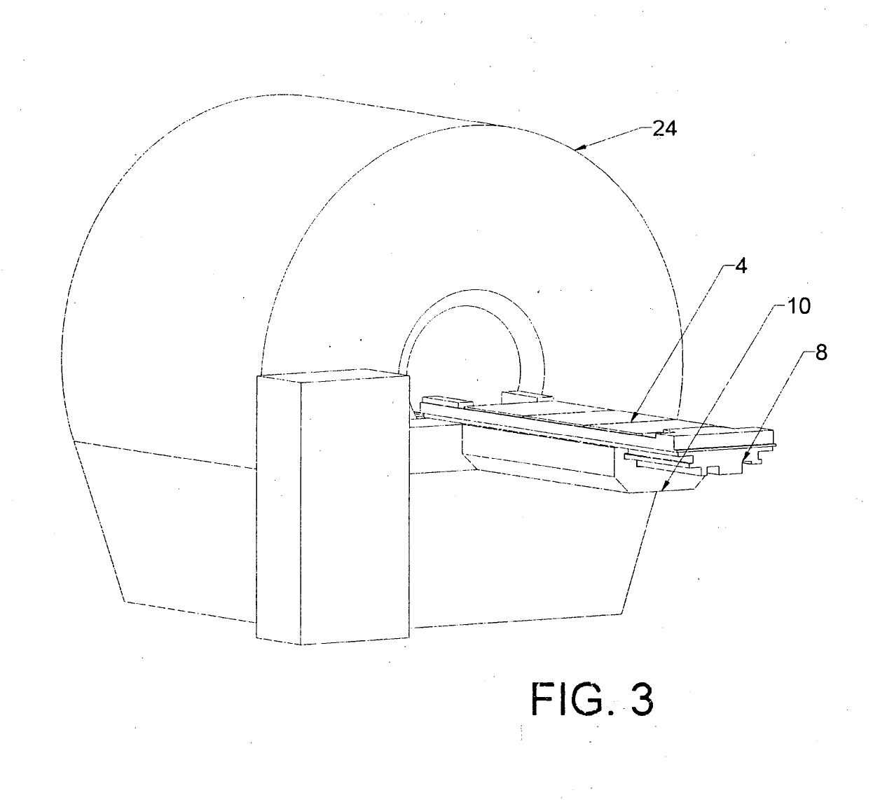

FIG. 3 (Prior art) shows a perspective view of an imager 24 showing the normal tabletop 4 at the home position. This is an approximate representation of a Siemens Avanto™ MM. See http://www.medical.siemens.com/siemens/en_US/gg_mr_FBAs/images/product_images/GG Overview/Product Overview Avanto HP5.ipg). The elements 8 and 10 are the same as in FIG. 2. All elements of same numbers in these figures represent the same or similar elements in all other figures.

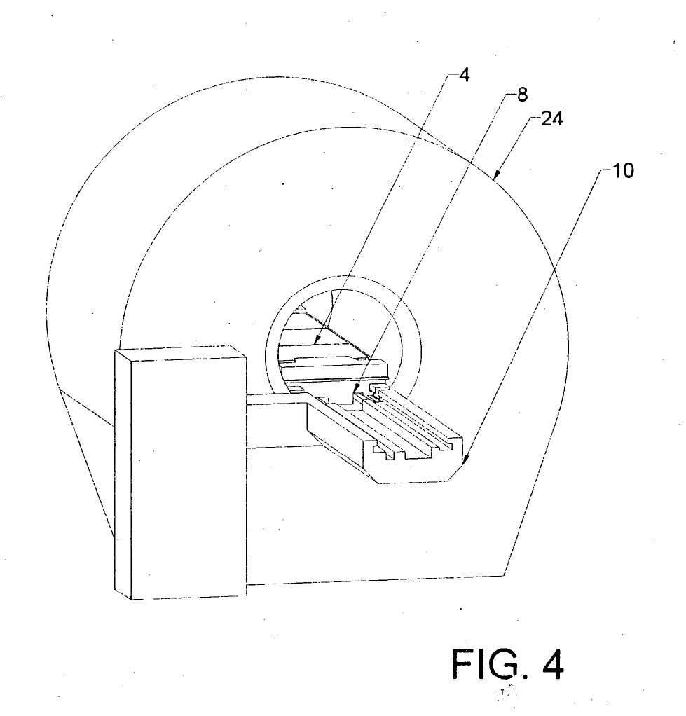

FIG. 4 (Prior art) shows a perspective view of an imager 24 with the normal tabletop 4 advanced by the horizontal stage 8 to the scan position within the imager.

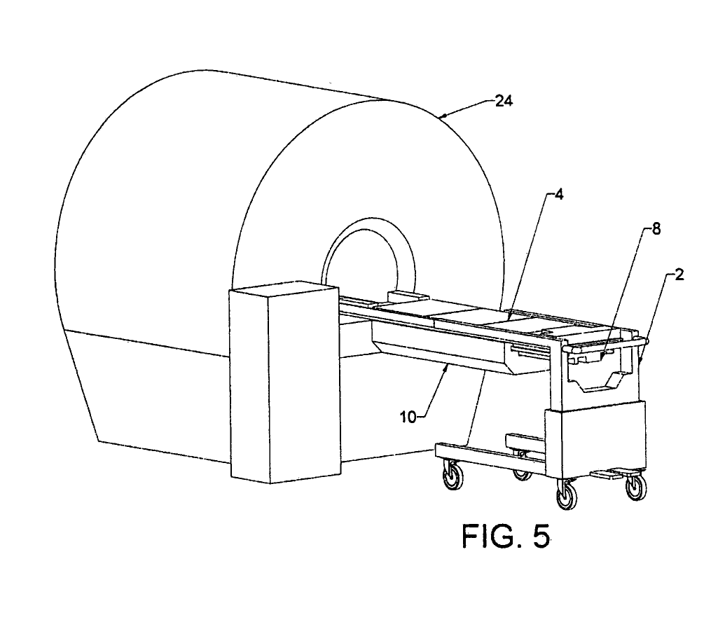

FIG. 5 (Prior art) shows a perspective view of an imager 24 with a transporter 2 engaged with the normal tabletop 4.

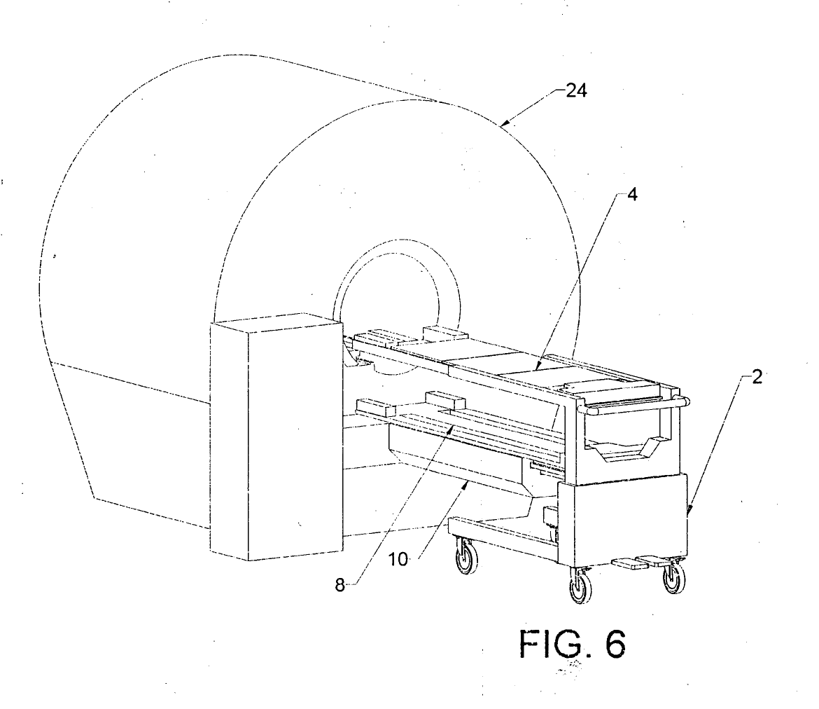

FIG. 6 (Prior art) shows a perspective view of an imager 24 showing a transporter 2 engaged with the normal tabletop 4 and the vertical 10 and horizontal 8 stages lowered in preparation for the removal of the tabletop 4.

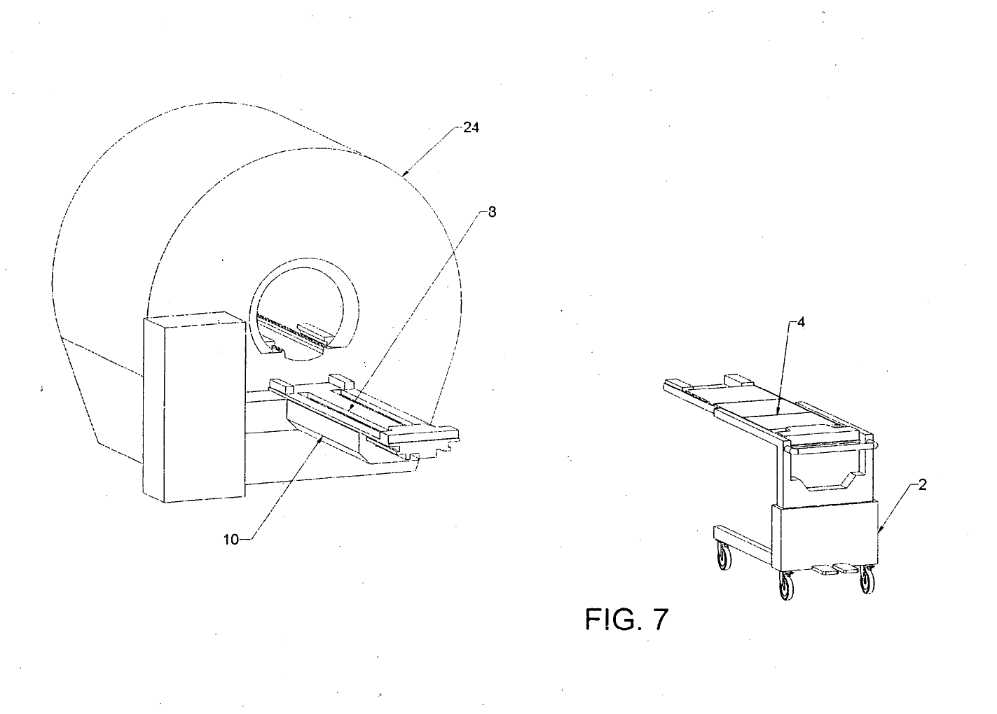

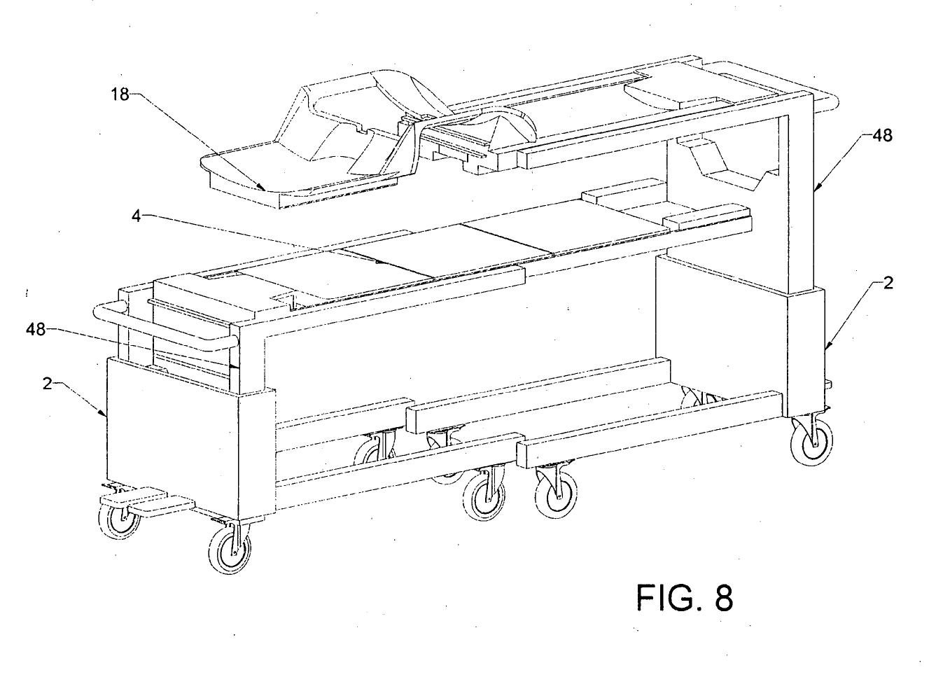

FIG. 7 (prior art) shows a perspective view of an imager 24 with its tabletop 4 withdrawn on a transporter 2.

FIG. 8 shows a perspective view of Siemens tabletop 4 (prior art element, and only substantive element of prior art in FIG. 8) on a transporter 2 (prior art) interleaved with an inventive special-purpose tabletop 18 according to the novel disclosure of technology that constitutes invention. Minimal space is used by interleaving them, while it is still possible to perform patient positioning or intervention on the uppermost tabletop 18 according to the novel teachings of the present technology.

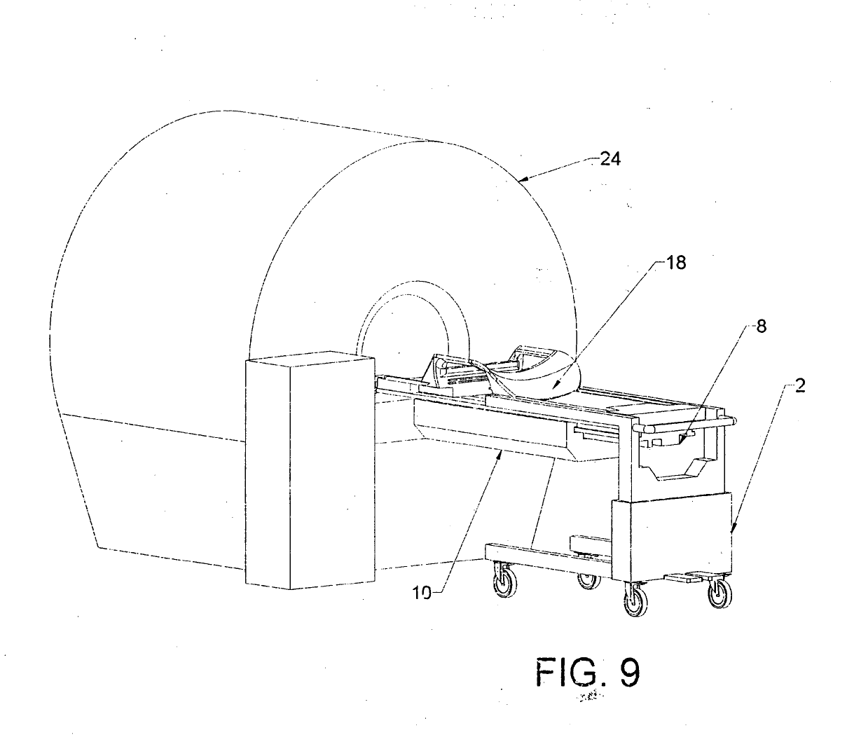

FIG. 9 shows a perspective view of a Siemens imaging system in combination with a specialized tabletop 18 installed in place of the normal tabletop on the horizontal stage 8 of the imager 24.

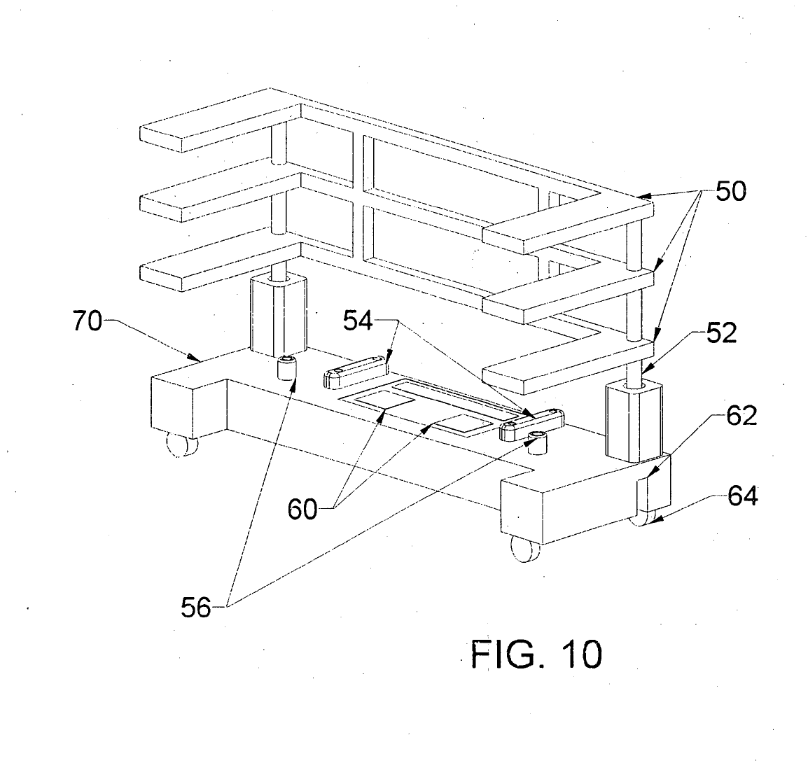

FIG. 10 shows a perspective view of a patient preparatory station 70 away from the imager that integrates lights 56, mirrors 60, position tracking devices 54, vertical adjustability 52, alignment element 62, casters or rollers 64, storage for multiple tabletops 50, and room for interventional access to a suitable tabletop.

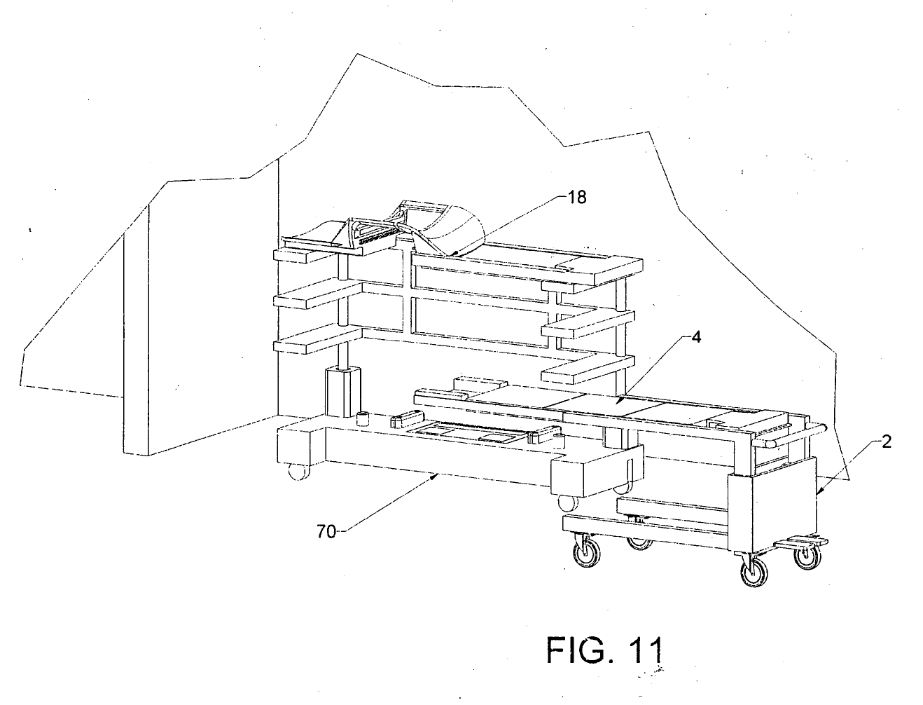

FIG. 11 shows a perspective view of a prep station 70 with a specialized tabletop 18 mounted, showing a Siemens tabletop element 4 (prior art) on a transporter 2 (prior art) being delivered to a second storage berth.

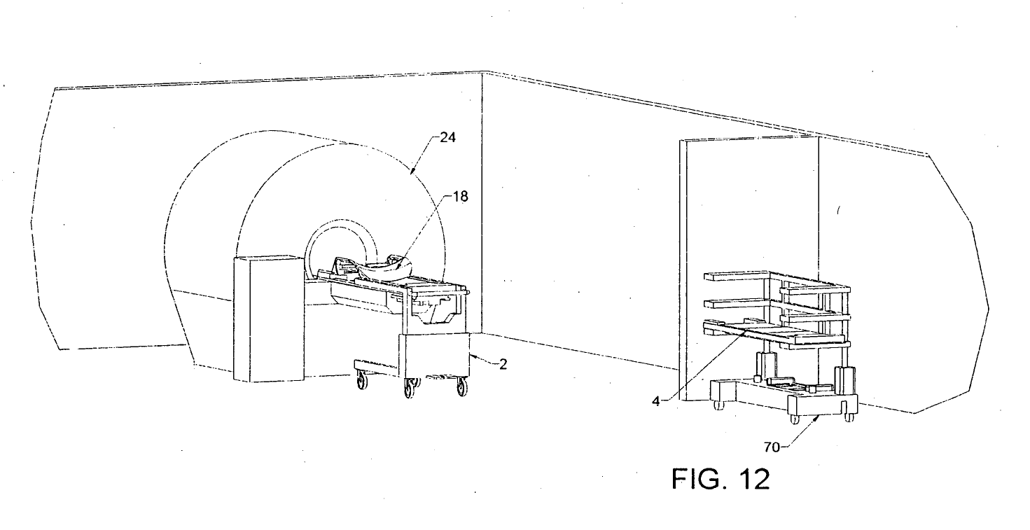

FIG. 12 shows a perspective view showing a specialized tabletop 18 removed from a prep station 70, and positioned on an imager 24. A Siemens tabletop element 4 (prior art) is stored on the prep station 70.

FIG. 13 (prior art) shows an exploded perspective view of an alternate imager 24, being representative of a Phillips magnetic resonance imaging system, whose vertically adjusting tabletop support 12 is affixed to the floor, and whose transporter 14 approaches from the side of the tabletop 6. The tabletop 6 has rollers 72 thereon so that the tabletop 6 is moved easily, but there are no engaging elements.

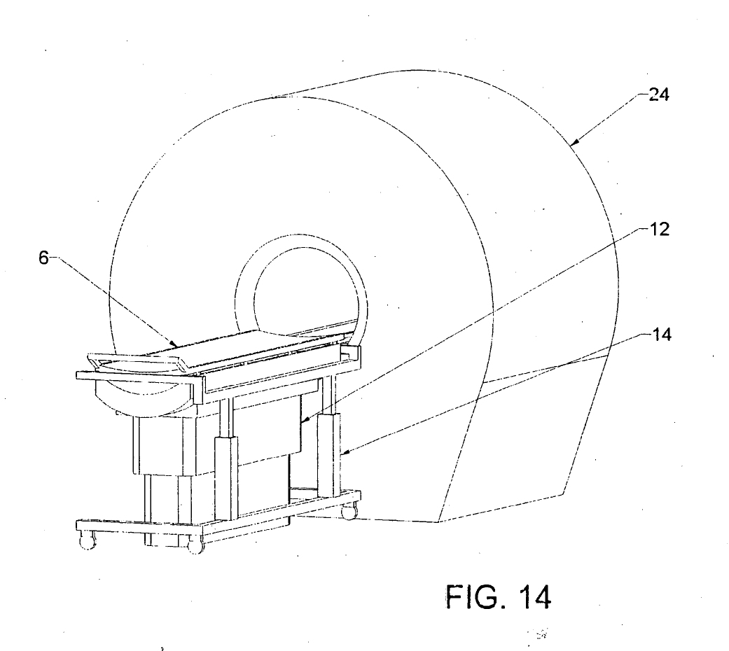

FIG. 14 (prior art) shows a perspective view of the Philips imager 24 in FIG. 13.

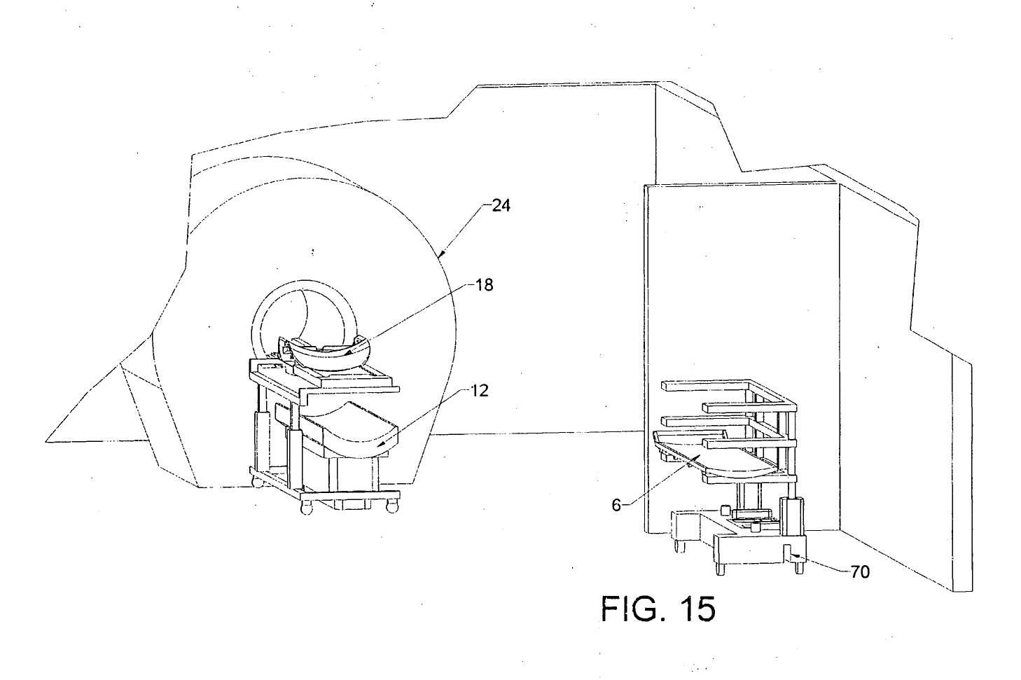

FIG. 15 shows a perspective view of the Philips imager 24, where the normal Philips tabletop 6 is stored on an inventive prep station 70, and a special-purpose tabletop 18 according to the present teachings is put in place using a transporter 12.

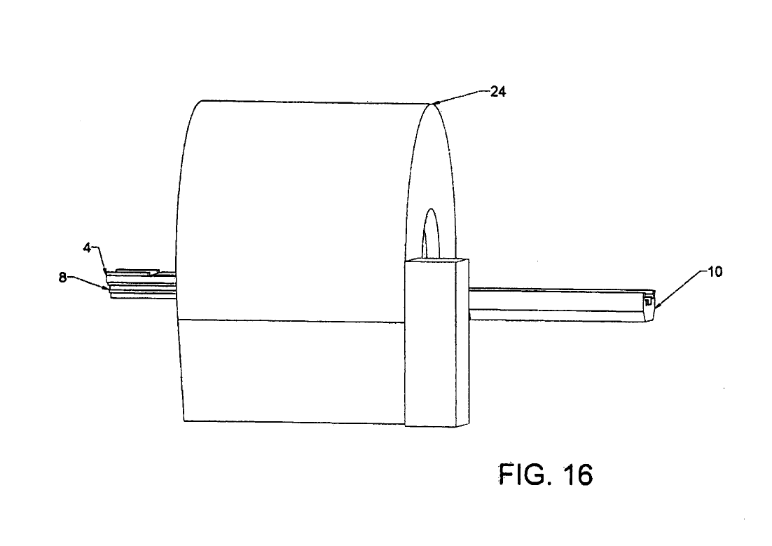

FIG. 16 shows a perspective view of an imager 24 showing how its tabletop 4 on the horizontal stage 8 may be advanced through its bore, so as to leave one end cantilevered out of the end of the imager opposite the vertical stage 10.

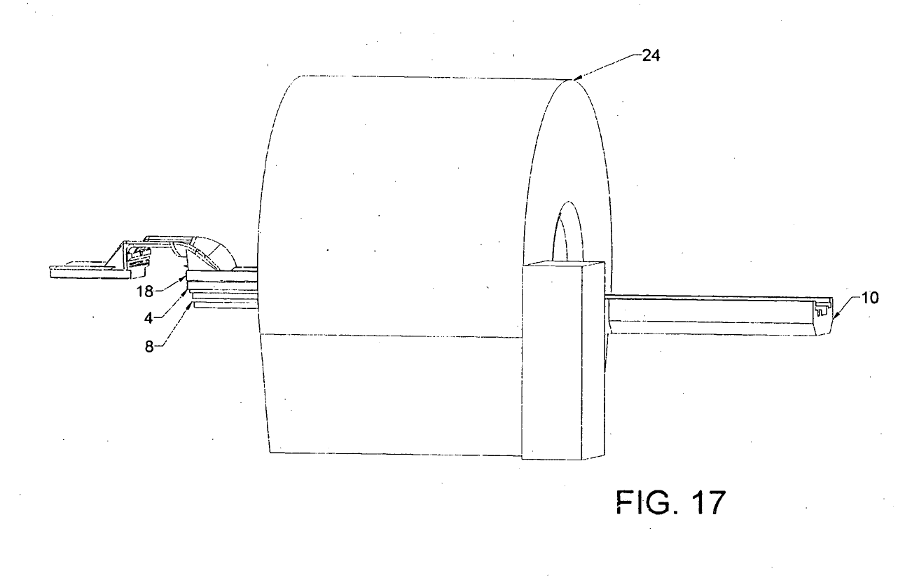

FIG. 17 shows a perspective view of an imager 24 with a special purpose tabletop 18 which sits on top of the normal tabletop 4 on a horizontal stage 8, overhanging it, and which is advanced through its bore in order to provide access to the patient through the tabletop's gap.

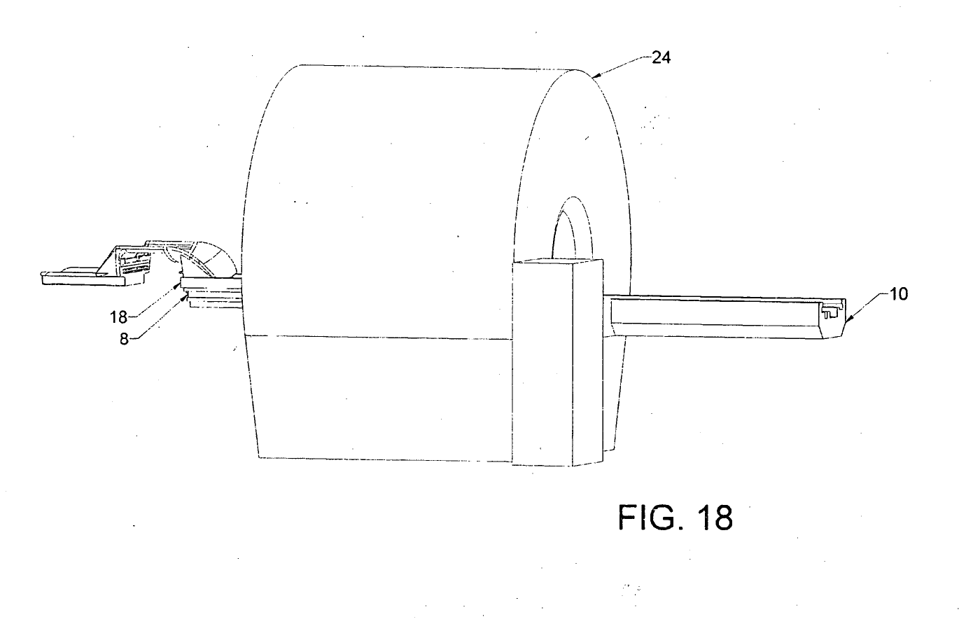

FIG. 18 shows a perspective view of an imager 24 with a special purpose tabletop 18 which sits in place of the normal tabletop, overhanging the horizontal stage 8, and which is advanced through its bore in order to provide access to the patient through the tabletop's gap. Grooves can be seen on the vertical stage 10 that engage with grooves on the horizontal stage so that movement of the tabletop 18 is secure, stable and controlled within the bore of the imager 24.

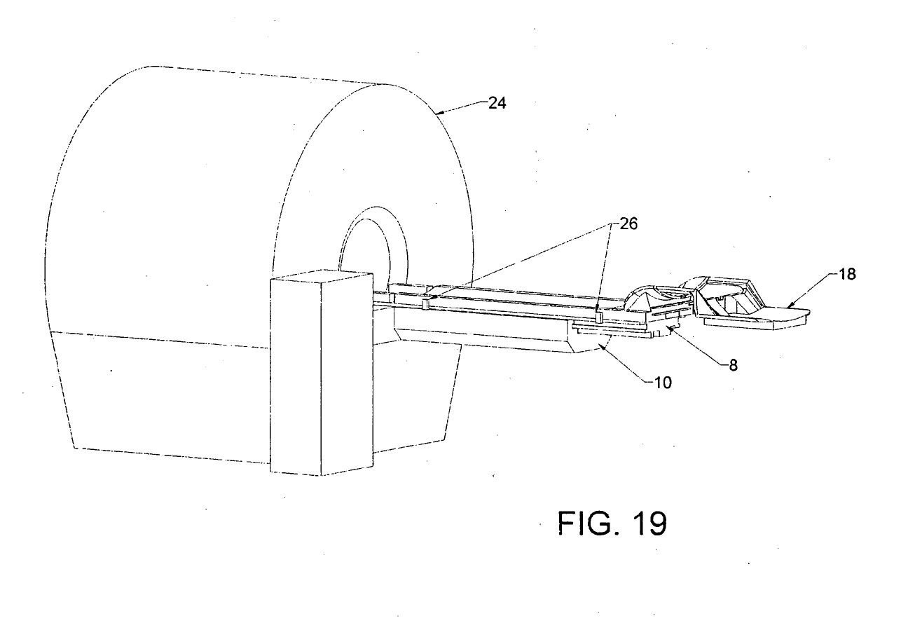

FIG. 19 shows a perspective view of an imager 24 with a special purpose tabletop 18 of the present technology which sits in place of the normal tabletop (not shown), overhanging the horizontal 8 and vertical 10 stages, in order to provide access to the patient through the tabletop's gap. Cantilever restraints 26 are shown to control movement of the tabletop 18 on the horizontal support 8.

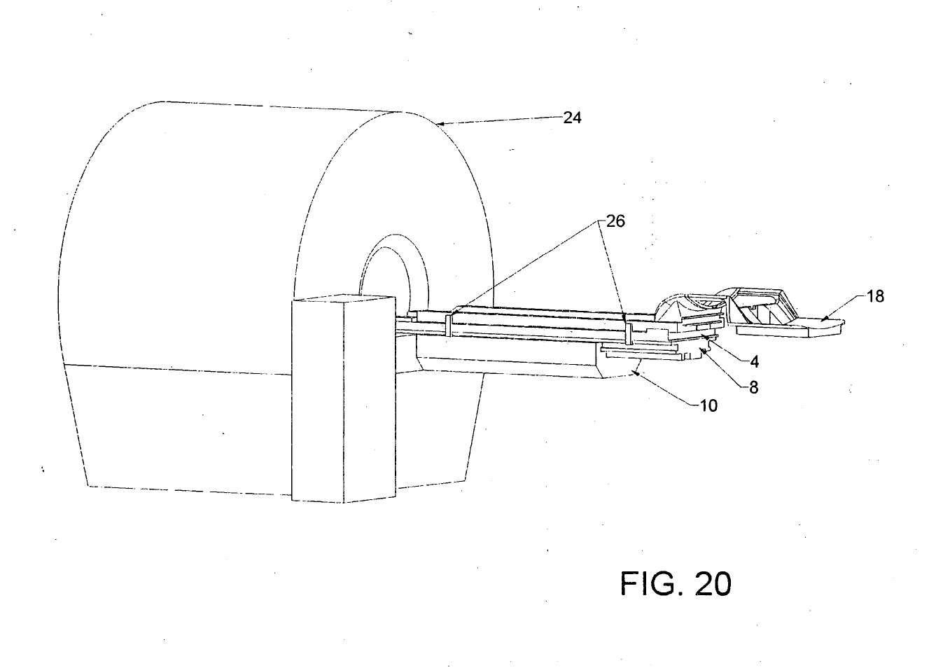

FIG. 20 shows a perspective view of an imager 24 with a special purpose tabletop 18 which sits on top of the normal tabletop 4, overhanging the normal tabletop and the horizontal support 8 and vertical 10 stages, in order to provide access to the patient through the tabletop's gap. Cantilever restraints 26 are shown extending further out of the horizontal support 8 to control movement of the tabletop 18 on the horizontal support 8.

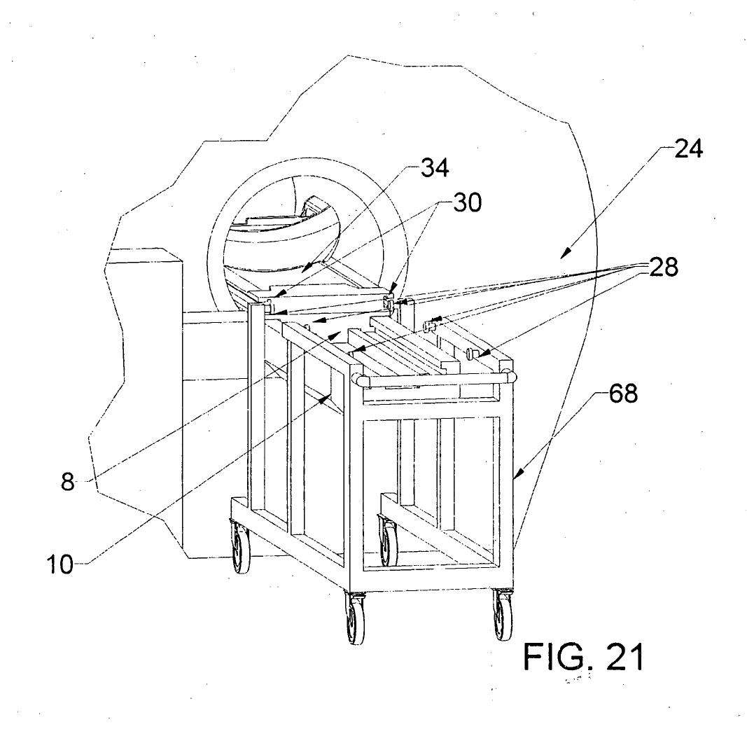

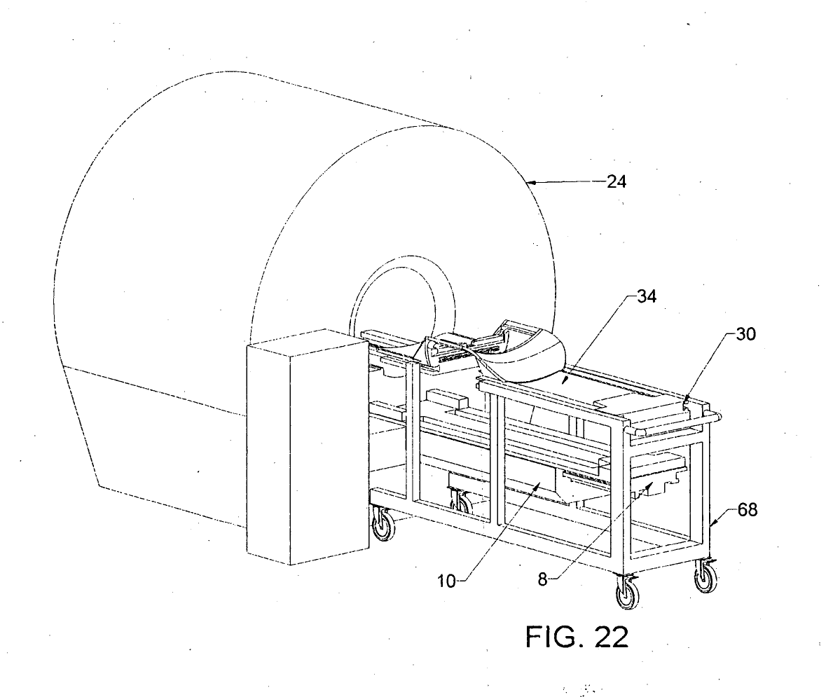

FIG. 21 shows a novel embodiment of a transporter 68 which carries a special purpose tabletop 18 which uses sliding rails 28 that permit translation only in the direction the tabletop 18 travels when advancing into the bore 34 to the scan position in the imager 24. T-slots 30 assure smooth maneuvering of the tabletop along sliding rails 28. Innermost (with respect to the bores) T-slots may having extending or retracting functions thereon to lock the tabletop or restrict the tabletop within the bore 34 and may be retracted or extended (respectively) to allow removal of the tabletop from the bore when desired.

FIG. 22 shows the transporter 68 and tabletop 18 of FIG. 21, where the imager's vertical stage 10 has been lowered to permit the removal of the transporter 68 and tabletop 18 of the present technology by disengaging from the tabletop 18. The main support of the tabletop has been labeled 34 in this figure.

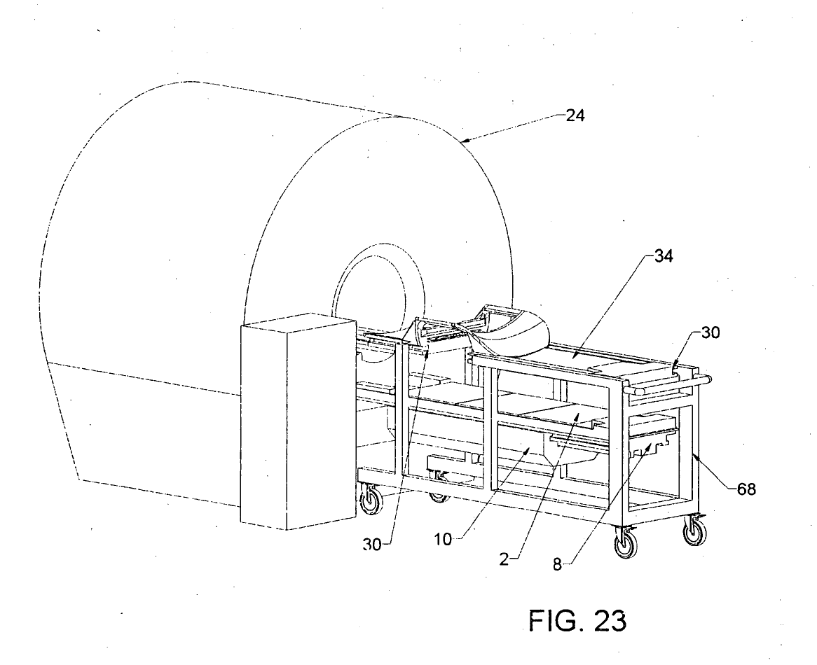

FIG. 23 shows an alternate embodiment of the transporter 68 and tabletop 18 of FIGS. 21-22, wherein the special purpose tabletop 18 is to be installed over the top of the normal tabletop. The main support of the tabletop has been labeled 34 in this figure.

FIG. 24 shows an alternate embodiment of a tabletop 84 for prostate intervention as a short prostrate tabletop, comprising a shorter tabletop 84 having ramps 86 and strut-supported stirrups 90 for leg support. Also shown is a pivot 92 allowing pronation or orientation of limbs, as in a prostrate table, to permit better access to the region of interest during invasive procedures.

FIG. 25 shows the tabletop 84 for prostate intervention of FIG. 24 where the tabletop 84 has been removed from the imager and where the stirrups or pivots 90 have been spread apart for improved interventional access.

Imaging on traditional tabletops does not always permit optimal patient positioning for imaging or for intervention. The patient position required for imaging is often different than that required for intervention. Additional features are built into a tabletop for constraining or repositioning a particular body part. Contours and apertures in a tabletop are used to immobilize or gain access to that body part. In order to reduce respiratory motion during imaging, breasts are advantageously imaged prone, and the prostate is best imaged supine. Positioning the patient in these ways effectively prevents physicians from accessing the tissues for intervention. But breast imaging and intervention may be performed prone where suitable ramps 38 and cutouts 66, 82 are provided in the tabletop. Similarly, prostate intervention may be performed supine if a cutaway 42, 98 is provided for the access of the physician.

Further improved access to the prostate is afforded by a tabletop such as that of FIG. 24 where the legs are supported by stirrups 90 on adjustable struts 88. Such a tabletop permits the physician to maximize the elevation and separation of the patient's knees for better access to prostate through the rectum, while maintaining a configuration that allows the patient to be advanced into the imager's bore. It may be further advantageous to separate the patient's legs once he is removed from the bore of the imager, which is accomplished by adjusting the stirrups 90 positions with the adjustable struts 88 supporting them (FIG. 25).

In general, these tabletops may be configured to ensure the patient's clearance from the bore of the imager, but may then be adjusted to provide patient positioning as preferred for intervention or surgery. This is particularly desirable when a patient will have pre-operative imaging done and will then undergo surgery. If the tabletop is adjustable in the same directions as a surgical table, e.g. with armboards, stirrups, head and neck positioning, etc, then the benefits of surgical positioning are had without the need to transfer the patient from the imaging tabletop. An adjustable tabletop of this kind could be place directly on top of a surgical table, or onto a transporter 2.

Respiratory motion of the liver and kidneys is minimized in tomographic imaging if the patient is positioned supine. In order to subsequently locate the same tissues with ultrasound, it is advantageous to not move the patient from the position held during tomographic imaging. In order to access tissues through the back of a supine patient, an ultrasound permeable membrane or aperture 36 is required.

The accessibility afforded by the present invention to devices used for other imaging modalities is complimented by the integration of position markers that can be identified using more than one imaging modality. If these points can be identified on two or more imaging modalities, they permit a co-registration of the coordinate systems used in those imaging modalities. It is also an established practice to use a position tracking device to track the positions and orientations of suitable tools, handpieces or markers (which can, in turn, be brought into a known relationship with markers visible on the images). Our invention facilitates registration with the tracker's co-ordinate system by providing a means of repeatably fixing such a tracker to the tabletop in a known position and orientation.

Position tracking devices that are compatible with the imaging technology may be integrated into the tabletop by being embedded in the structure of the bed. As with the trackers above that repeatably affix to the tabletop, integrated trackers typically have an optimal working range or may require a line of sight to function, so the exact position of the tracker within the tabletop is chosen to suit the tracker's characteristics and the anatomy under investigation.

Since RF energy deposition resulting in heating is a common feature of MRI, it is advantageous to provide a tabletop with integrated temperature control to cool the patient or sample under investigation. Alternatively, a heating tabletop may be provided for use with patients under sedation who would otherwise be in danger of hypothermia. The means commonly used to control patient temperature may not be as well suited to tomographic imaging, as size limitations of the bore 34 of the imager may make conventional approaches unsuitable. We propose a tabletop having an array of passages connecting to a means of supply and return of a fluid used to transfer heat to or from the patient, through a thermally conductive tabletop. The fluid is chosen to avoid contributing any signal or any contrast effect to the imaging means. A temperature sensor such as a thermistor or thermocouple is advantageously integrated to improve the means of temperature control and prevent extremes of temperature at or near the patient's skin. Alternatively, in the absence of fluid flow, thermoelectric cooling or electric heating elements can be integrated into the tabletop.

In many cases, it is desired to use X-ray C-arm imaging to gather more images of the particular tissues under examination. Traditional tabletops limit this capability by introducing structural elements of the tabletop into the field of view. In accordance with the present invention, it is possible to provide a tabletop having an integrated X-ray detector 44 which is mounted adjacent to the patient without excess structural elements intervening.

For MR imaging, tabletops may integrate specialized MRI coils (receiver or transceiver antennae) to improve coil sensitivity, according to the inherent needs of imaging a particular body part. Alternatively, tabletops may integrate fixtures for the rigid attachment of modular, re-positionable coils which permit those coils to be brought closer to the anatomy to improve coil sensitivity and can be positioned for each patient to guarantee unencumbered access for interventional devices. Interchangeability provides an option either to integrate coils into the table top or to permit removable, re-positionable or interchangeable coils for use on different magnets with different field strengths, for use in spectroscopy or for use on different imagers having different numbers of channels.

In conjunction with this invention, transporters are used to displace tabletops and any patients thereon, to maintain the position of the tabletop when the imager's vertical stage is lowered, so as to permit access to the patient by making use of a gap or aperture in the bottom of the tabletop, and to raise the tabletop higher than its normal position, to ease physician access to the underside of tabletops. Alternately, the tabletop may be raised higher than its normal position with a prep station.

Intervention is performed on the table top with the patient in the same configuration as during tomographic imaging. The tabletop and patient may remain in the imaging volume of the imager (FIG. 4), may be removed to the home position (FIG. 3), may be removed to a point in between the home position and the imaging volume, may be removed from the imager entirely using a transporter, or may be transported to a different room entirely. Creating clearance underneath the tabletop is useful for access to gaps, cutaways and apertures in the tabletop. This may be done by positioning the tabletop at the home position with the imager's vertical stage 10 lowered (FIG. 15), or with the tabletop and patient on the transporter (FIG. 8) or prep station (FIG. 11). An alternative means of fitting specialized table tops in such a way as to gain access to gaps, cutaways or apertures is to cantilever a portion of the tabletop over the near (FIG. 19) or far end (FIG. 18) of the imager's horizontal stage 8. Alternatively, such a cantilevered tabletop may be fitted over top of the normal tabletop 4, and extended over the near (FIG. 20) or far end (FIG. 17). Camping or latching constraints 26 may be used to prevent separation of a cantilevered tabletop from its support.

Time savings resulting from remote patient preparation is not a novel aspect of this system. The patient preparatory station may also integrate any of:

position tracking devices which use stereoscopic optical cameras or electromagnetic transmitters and receivers to make rapidly repeated measurements of the position and orientation of a marker, which marker is affixed to a patient tissue, a tabletop, an interventional device such as a biopsy needle, or an imaging device such as an ultrasound transducer.

mirrors disposed in a horizontal or near horizontal plane near the bottom of the structure, used to aid in positioning patients by permitting visualization of tissues visible through apertures in the underside of tabletops.

height adjustability of tabletops by means of sliding or telescoping elements, tabletops being raised to ease physician access to tissues accessible from under a tabletop, and lowered to facilitate patients getting on and off of tabletops.

system for fully supporting a tabletop, which tabletop has one or more structural elements removed from its fixation components, such as additional support arms disposed at regular intervals along the length of the area which receives tabletops.

components or systems for locking down a tabletop with a mechanical safety interlock such as a clamp when one or more of its structural elements has been removed such that transport of the tabletop in an unsafe condition is prevented.

Equipment used to facilitate vacuum assisted biopsy, such as a vacuum pump, fluid handling means and control electronics. The integration of this equipment inside the prep station permits convenient use and storage of vacuum biopsy equipment without requiring separate equipment to be brought into proximity with the patient.

Wheels to facilitate relocation of the prep station, which wheels have swivel and rolling locks to prevent the unintentional displacement of the prep station.

guidance means and suitable mechanical interlocks to ensure that transporters may only release tabletops onto the supports of a prep station when those transporters are correctly positioned relative to the prep station.

collection means for collection of bodily fluids, embodied either as a drain and storage tank which interfaces with and receives fluid from a fluid collection means integrated in a tabletop, or a catch basin, drain and storage tank which collect fluids which are not collected by a tabletop, such as those that issue from a gap in the tabletop. Pressure control and vacuum control in the collection means is contemplated, as are one-way flow systems, one way valves and meters.

storage such as drawers and shelves in the prep station for accessories such as imaging or interventional equipment, in addition to the multiple tiers for receiving multiple tabletops.

a shelf or shelves that may be used to support an ultrasound imaging machine, a biopsy tray or other imaging or interventional equipment when such equipment is being used in a location close to the patient which is visible to and accessible to the physician, such as under the tabletop bearing the patient.

a means of repositioning all or part of the patient without entirely removing the patient from the tabletop such as the provision of adjustable armboards or stirrups near the tabletop or the ability to provide inclination/declination of a tabletop (or a portion of the tabletop so that it may bend at a longitudinal joint and/or a joint perpendicular or angled to the longitudinal aspect of the tabletop) such as Trendelenberg positioning by means of individually height adjustable tabletop support arms.

side rails sized as the standard surgical side rail for the fixation of accessories.

In further accordance with the invention, and in order to use more than two tabletops described above, it is advantageous to have an efficient means of storing or stacking tabletops. FIG. 10 illustrates a prep station 70 used for that purpose. It may be kept in proximity to the imager, or in a separate room. It is used for storage of tabletops, preparation of patients for imaging, and for procedures carried out on a table top subsequent to imaging.

It comprises a vertically adjustable array of storage berths 50 which accept and support tabletops. Its vertical adjustability using slides 52 permits any tabletop from a large selection to be transferred to and from a transporter, whether or not that transporter is itself vertically adjustable. The topmost berth may be used for positioning a patient, or carrying out procedures such as intervention. The vertical adjustability is of sufficient range to permit the topmost berth to be brought to a suitable working height for the physician to perform subsequent intervention or non-tomographic imaging.

The prep station may be mounted on wheels 64 for convenience of use and storage in various locations. The prep station, although fitted with wheels, is different than a transporter, in that it may contain materials or apparatus which are not suitable for proximity to, or for use in proximity to an imager such as an MRI. It is intended to accept tabletops from transporters. It has integrated channels 62, rails or other guidance means used to repeatably guide transporters into position for the addition and removal of tabletops. Additionally, it may be brought to and used in a surgical suite.

Advantageously, and in accordance with the preferred embodiment of the invention, it comprises lights 56, a fluid catchment 58, position tracking devices 54 and mirrors 60 for use performing interventions when suitable tabletops are used. The tabletops reside in a known position relative to these lights and position tracking devices.

Further advantageously (FIG. 21), a simple type of transporter 68 may be used in connection with imagers having a vertical stage 10, 12, which relies on the lowering of that vertical stage to engage the tabletop on the transporter, removing it from the imager, and does not require any clamping or locking mechanism in order to support and transport the tabletop. The simplified transporter 68 employs constraints 28 which correspond to slides or rails 30 on the tabletops used therewith 34. The slides or rails permit horizontal translation of the tabletop between the home position and the imaging volume, but do not allow the tabletop to be lowered on the vertical stage. If the vertical stage is lowered, the tabletop remains fixed on the simplified transporter and can be removed from the imager (FIG. 22).

An alternate embodiment of the system described above and shown in FIG. 21, 22 is shown in 20 FIG. 23. This transporter and tabletop are sized and disposed appropriately to permit placement of a special purpose tabletop over top of the normal tabletop 2, or a similar special purpose tabletop such as a tabletop with an aperture for ultrasound 16. This is accomplished by lowering the vertical stage 10, which carries the normal tabletop 2. The special purpose tabletop 34 is then brought into alignment with the normal tabletop on the vertical stage, and the vertical stage is raised until the special purpose tabletop 34 is supported by the imager's vertical stage and the normal tabletop. In this way, the necessity of picking up and displacing the existing tabletop is removed. The special purpose tabletop 34 is advantageously constructed to be thin so as to minimize the space required in the imaging volume for the extra tabletop. This approach is also very suitable for imaging systems whose tabletops are not removable.

The technology may be used in such surgeries such as for example, in a prostate biopsy, where a man lies on his back, with legs sightly splayed (still fitting into the bore of the imager) and his thighs lie directly above the aperture. A physician then uses the cutaway (e.g., the hole extending completely to and through an edge of the tabletop (as in FIG. 1, Table 20) to gain access to reach between the patient's thighs and for the physician to insert a needle into the perineum.

The tabletop may also be constructed of lightweight construction such that the tabletop can be placed by hand over top of or in place of an imager's general-purpose tabletop in such a way that a transporter can be used to remove later it with a patient on it.

The invention may be described as including various distinct elements, including at least a tabletop for use in medical procedures comprising a support surface for a patient and engaging elements on a) at least two lateral sides or b) at the bottom of the tabletop under the support surface for engaging guiding means that comprise i) part of an imager, ii) part of a preparatory station, or iii) patient transporter. The tabletop may comprise at least one structure selected from the group consisting of:

structure other than a single extended flat surface that supports specific portions of the human anatomy;

apertures in the structural support surface that allows for body parts to extend through the holes to provide access to those body parts during medical examination or procedures;

apertures in the structural support surface that allows interventional or imaging devices to extend through the holes to gain access to body parts during medical examination or procedures;

structural elements on the tabletop that support specific portions of the human anatomy and are adjustable to fit or accommodate patients or body parts of patients of different dimensions.

Adjustable body support elements that are removable, adjustable and replaceable manually (without wrenches or screwdrives);

structural elements such as bridging elements connecting sections of a tabletop, that are removable in order to gain access to patient tissues.

structure that supports, guides and secures interventional medical devices while allowing those devices to be used for medical procedures,

optical or electromagnetic position trackers having a reference component fixed to the tabletop 25 which measures the position of a movable tracked component attached to an interventional or imaging device;

cooling means integral with the tabletop;

a pneumatic or hydraulic system for motivating the tabletop or components on the tabletop (such as longitudinal expansion, compression plates, aperture walls, etc.),

fluid drainage paths and connector to a fluid receptor on that fluid path,

controlled pressure bladders for assisting in the comfortable positioning of patients, pressure controls for the bladders so that they may be inflated or deflated to alter points of support for patients to relieve local stress on the patient,

actuators for attachments to limbs or joints of patients to assist in the manipulation of the limbs or joints during medical procedures or imaging,

remote control system for the actuators,

engaging system on the sides and/or bottom of the tabletop to engage support elements on a transporter, and

latching or locking elements to secure the tabletop to structures on which the tabletop is placed.

The tabletop may specifically comprise an elongated patient support plane and an opening in the patient support plane allowing body parts to pass into the opening when a patients front lies on the patient support plane, the tabletop having engaging guide supports along at least one of a) both lateral longitudinal edges of the tabletop and b) along the bottom of the tabletop, the engaging guide supports allowing the tabletop to be slidably engaged with guides on at least one of a transporter, imager or preparatory station. The tabletop may have the opening positioned on a location of the support plane such that a patient lying on his/her front against the support plane will have body parts exposed and accessible through the opening, the opening comprising at least one of a fixed-size aperture in the support plane, an adjustable aperture in the support plane, or an opening in the support plane that extends to the edge of the support plane. This tabletop may further comprise at least one elevated arch element on the support plane which can support specific body portions of a patient. The arch support element may be adjustable in at least one dimension of height and width, or the arch support element can be removed or securely positioned by snap engagement or manually controlled clamp engagement. There may be inflatable/deflatable bladders present on the support plane to assist in positioning or comforting a patient. The adjustable limb support elements may be secured to the tabletop to support at least one limb of a patient while positioned on the tabletop. The tabletop may comprise rails, slides or clamping arms suitable for the fixturing of coils in positions adjustable in at least two degrees of freedom such that said coils may be held motionless in positions close to the patient's tissues, above the tabletop's surface.

The novel technology of this application may also comprise a method of performing an imaging or interventional medical procedure on a patient comprising positioning a patient on the tabletop described above, and imaging the patient or performing an interventional medical procedure on the patient. The method may allow a portion of the patient to extend downwardly through an aperture in the tabletop and an interventional procedure is performed on the patient through the aperture. The method may have the interventional procedure performed after the patient is imaged with an imaging technology selected from the group consisting of X-ray imaging, PET, magnetic resonance imaging, ultrasound imaging, and computerized x-ray tomography, or remote controlled interventional apparatus is used to perform the interventional procedure, and materials in the interventional apparatus do not interfere with the imaging technology to a degree that prevents functional viewing of the interventional procedure. The method may have the tabletop with a patient thereon positioned within an imager, images are taken of a region of the patient associated with the portion of the patient, the tabletop with patient is removed from the imager, and an interventional technique is performed on the region of the patient. A method of may be practiced wherein at least one tabletop according to the above descriptions is provided for association with a device that supports the tabletop comprising providing a prep station with at least two tabletops carried on the prep station in slidably removable position and sliding one of the at least two tabletops onto another support element having fitted support for receiving the one of the at least two tabletops.

A novel system for use in medical procedures comprises an imager, a transporter, a tabletop, and a preparatory station comprising:

a preparatory station comprising a moveable assembly having multiple ports, each port for acceptance and removal of a tabletop by allowing the tabletop to slide along a guiding system into and out of a port,

the transporter and the imager having a tabletop guiding system that allows a tabletop compatible with the preparatory station to be accepted and guided by the guiding systems on the transporter and imager.

The use of removable structural elements 76 in special purpose tabletops 74 (FIG. 1) is advantageous for a number of reasons. Removal of one or more structural elements permits simplified patient handling and positioning when the tabletop is adequately supported underneath and along its length. It may be advantageous to affix the tabletop to this support with an interlock until its removable elements have been replaced and it is ready for transport. After imaging and transporting the patient back to a stable support such as a prep station 70, the structural element may be removed for optimal interventional access and patient comfort.

What is claimed:

1. A tabletop for use in medical procedures comprising a support surface for a patient and engaging elements on
a) at least two lateral sides or
b) at the bottom of the tabletop under the support surface
for engaging guiding components that comprise
i) part of an imager,
ii) part of a preparatory station, or
iii) patient transporter,
the tabletop comprising at least one structure selected from the group consisting of:
a supporting structure other than a single extended flat surface that supports specific portions of the human anatomy;
apertures in the structural support surface that allows for body parts to extend through the holes to provide access to those body parts during medical examination or procedures;
apertures in the structural support surface that allows interventional or imaging devices to extend through the holes to gain access to body parts during medical examination or procedures;
structural elements on the tabletop that support specific portions of the human anatomy and are adjustable to fit or accommodate patients or body parts of patients of different dimensions;
adjustable body support elements that are removable, adjustable and replaceable manually;
structural elements such as bridging elements connecting sections of a tabletop, that are removable in order to gain access to patient tissues;
structure that supports, guides and secures interventional medical devices while allowing those devices to be used for medical procedures;
optical or electromagnetic position trackers having a reference component fixed to the tabletop which measures the position of a movable tracked component attached to an interventional or imaging device;
cooling means integral with the tabletop;
pneumatic or hydraulic system for motivating the tabletop or components on the, fluid drainage paths and connector to a fluid receptor on that fluid path;
controlled pressure bladders for assisting in the comfortable positioning of patients;
pressure controls for the bladders so that they may be inflated or deflated to alter points of support for patients to relieve local stress on the patient;
actuators for attachments to limbs or joints of patients to assist in the manipulation of the limbs or joints during medical procedures or imaging procedures;
remote control system for the actuators;
engaging system on the sides and/or bottom of the tabletop to engage support elements on a transporter, and
latching or locking elements to secure the tabletop to structures on which the tabletop is placed.
